(19) United States
(12) Patent Application Publication
(10) Pub. No.: US 2007/0129084 A1
(43) Pub. Date: Jun. 7, 2007

(54) Creating and recognizing user-defined locations using communication terminals

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/294,053

(22) Filed: Dec. 5, 2005

(51) Int. Cl. H04Q 7/20

(52) U.S. Cl. 455/456.1

(57) ABSTRACT

The present invention allows a communication terminal to monitor signal metrics of received signals for a defined location and create a signal signature for the defined location. The defined location may be a position, an area about a position, or a defined area. After the signal signature for the defined location is created, the communication terminal will compare currently monitored signal metrics for received signals with the signal signature during normal operation. Upon returning to the location, the communication terminal will monitor signal metrics for signals being received at the location and detect when the current signal metrics correspond to the signal signature for the location. The correspondence of the new signal metrics with the signal signature indicates that the communication terminal is at a defined location.

### FIELD OF THE INVENTION

The present invention relates to location detection, and in particular to creating and recognizing user-defined locations using communication terminals.

### BACKGROUND OF THE INVENTION

With the evolution of mobile communications, many applications benefit from or require information bearing on the location of a mobile user. Presence applications track the location and movement of the mobile user in an effort to determine when and how to initiate communications with the mobile user. Emergency and customer service applications use location information to direct emergency or customer related services to the mobile user. Other applications may operate to activate items or make selections based on the mobile user's location.

To determine the mobile user's location, most technologies rely on Global Positioning System (GPS) receivers integrated into the mobile user's communication terminal or on location services provided by the network. The network location services may use triangulation techniques or location detection methods to determine the communication terminal's location and send the information to the communication terminal or a location-based application residing on the network.

When using GPS, an additional GPS receiver must be incorporated in the communication terminal at additional expense and complexity. Further, GPS signals are difficult to receive when the communication terminal is within a building or proximate to certain structures. When using network-based location techniques, additional network infrastructure and resources are required to determine the mobile user's location. With either technique, the mobile user is generally relegated to the communication terminal or the network associating their current locations with either GPS coordinates or predefined locations. There are many instances where it would be beneficial to allow the mobile user to define a custom location for use with location-based applications.

Accordingly, there is a need for a more efficient and effective technique to determine a mobile user's location without requiring GPS or dedicated network location detection techniques. There is a further need for the technique to allow the mobile user to define locations and have the communication terminal recognize when it is at the defined locations.

### SUMMARY OF THE INVENTION

The present invention allows a communication terminal to monitor signal metrics of received signals for a defined location and create a signal signature for the defined location. The defined location may be a position, an area about a position, or a defined area. After the signal signature for the defined location is created, the communication terminal will compare currently monitored signal metrics for received signals with the signal signature during normal operation. Upon returning to the location, the communication terminal will monitor signal metrics for signals being received at the location and detect when the current signal metrics correspond to the signal signature for the location. The correspondence of the new signal metrics with the signal signature indicates that the communication terminal is at a defined location. The signal metrics may relate to the characteristics of the received signals, the type of the received signals, the content of the received signals, or any combination thereof.

The present invention allows a user to control the communication terminal to define the defined location. The user will activate a location acquisition mode at the location to be defined to cause the communication terminal to monitor the signal metrics of received signals and generate the signal signature for the defined location. The user can then provide a location identifier, such as a name, corresponding to the signal signature. As noted, the defined location may be a position, an area about a position, or a defined area. Determining the signal signature for the defined area may require gathering signal metrics at various points within or around the defined area. The signal signature will be a function of the signal metrics monitored at the various points.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 illustrates a communication terminal creating a signal signature for a defined area according to one embodiment of the present invention.

FIGS. 3A-3E represent signal metrics derived from received signals at different positions along the perimeter of the defined area illustrated in FIG. 2.

FIG. 3F is a signal signature based on the signal metrics provided in FIGS. 3A-3E.

FIG. 4 is a flow diagram illustrating operation of a communication terminal when creating a signal signature for a defined location according to one embodiment of the present invention.

FIG. 5 is a flow diagram illustrating operation of the communication terminal when detecting whether the communication terminal is within a defined area according to one embodiment of the present invention.

FIG. 6 is a block representation of a communication terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows a communication terminal to monitor signal metrics of received signals for a defined location and create a signal signature for the defined location. The defined location may be a position, an area about a position, or a defined area. Subsequently, the communication terminal will compare currently monitored signal metrics for received signals with the signal signature. Upon returning to the location, the communication terminal will monitor signal metrics for signals being received at the location and detect when the current signal metrics correspond to the signal signature for the location. The correspondence of the new signal metrics with the signal signature indicates that the communication terminal is at a defined location. Notably, the signal signature need not include all of the signals metrics that are monitored.

The signal metrics may be derived from signals received from the same or different entities. The different entities may be associated with the same or different networks, which may employ different communication technologies. For example, the communication terminal may be configured to facilitate cellular communications and local wireless communications, such as those used in wireless local area networks (WLANs) or Bluetooth communications. As such, signal metrics for cellular and local wireless signals from multiple base stations and wireless access points may be simultaneously monitored when creating a signal signature or determining whether the communication terminal is at a defined location.

The signal metrics may relate to the characteristics of the received signals, the type of the received signals, the content of the received signals, or any combination thereof. The characteristics of the received signals may correspond to signal or power levels or strengths, carrier frequency, and modulation attributes. The signal type may bear on whether the received signals are a cellular or local wireless signal as well as the particular type of cellular or local wireless signal. The content may take virtually any form; however, identification information identifying the base station, access point, sub-network, cell, zone, access network, or network from which the received signals originated is particularly beneficial with the present invention. Those skilled in the art will recognize other useful signal metrics to monitor when implementing the present invention. The examples illustrated above are provided merely for illustration and not intended to provide a comprehensive list of available signal metrics.

The present invention allows a user to control the communication terminal to define the defined location. The user will activate a location acquisition mode at the location to be defined to cause the communication terminal to monitor the signal metrics of received signals and generate the signal signature for the defined location. The user can then provide a location identifier, such as a name, corresponding to the signal signature. As noted, the defined location may be a position, an area about a position, or a defined area. Determining the signal signature for the defined area may require gathering signal metrics at various points within or around the defined area. The signal signature will be a function of the signal metrics monitored at the various points. Numerous processing techniques may be employed to effectively form a signal signature for the defined area from the signal metrics taken at the various points, such that the communication terminal will be able to subsequently determine when it is anywhere within the defined area based on monitoring signal metrics of received signals.

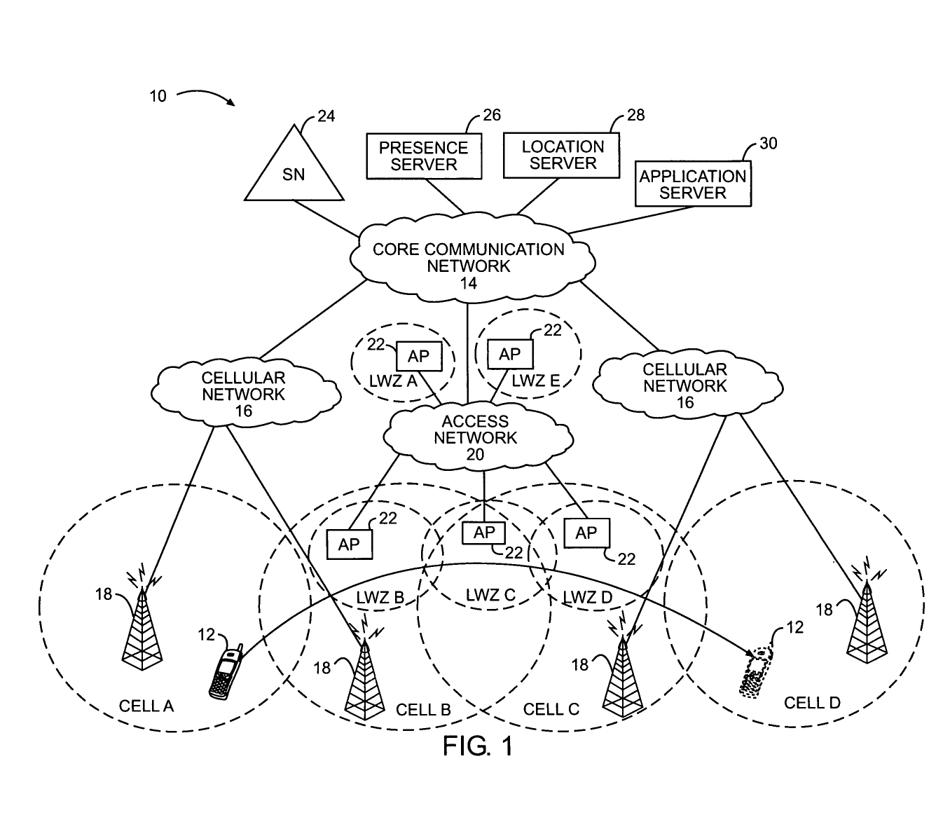

Prior to delving into select embodiment of the present invention, an overview of a communication environment 10 in which the present invention may be practiced is provided in FIG. 1. As illustrated, the communication environment 10 supports communications for a communication terminal 12, which may take the form of a mobile terminal facilitating cellular communications, local wireless communications, or a combination thereof. The local wireless communications are defined as relatively limited range communications with respect to the traditional cellular communications, and may be supported using various WLAN technologies, such as those set forth in the IEEE's 802.11 standards and Bluetooth standards. Those skilled in the art will recognize other local wireless communication technologies.

A core communication network 14 may support one or more cellular networks 16 that use base stations 18 to support wireless communications using cellular technologies with the communication terminal 12. As illustrated, the four base stations 18 form overlapping cells A-D in which cellular communications are possible. Notably, adjacent ones of the cells A-D overlap one another.

Local wireless communications are supported through an access network 20 and corresponding access points (APs) 22. As illustrated, each of the access points 22 provides a relatively limited range local wireless zone (LWZ) in which local wireless communications with the mobile terminal 12 are possible. The five access points 22 in FIG. 1 support local wireless zones A-E. Local wireless zones A and E are outside of the cellular coverage and isolated from one another. Thus, when the communication terminal 12 is within either local wireless zone A or local wireless zone E, only signals from the local wireless zone A or E, respectively, can be received. Local wireless zones B-D partially overlap one another, as illustrated. Further, local wireless zones B-D are collocated with cell B, cell C, or a combination thereof. In particular, local wireless zone B is within an upper portion of cell B, local wireless zone D is in an upper portion of cell C, and local wireless zone C has a portion collocated with only cell B, a portion collocated only with cell C, and a portion collocated with portions of both cell B and cell C.

As such, when the communication terminal 12 travels along the path (solid line) from cell A to cell D, there are positions along the path where only cellular communications are available, as well as where local wireless and cellular communications are available. Further, there are portions along the path where the mobile terminal 12 will be able to receive signals from multiple base stations 18, multiple access points 22, as well as multiple access points 22 and multiple base stations 18. The ability to receive signals of different types and from different access points 22 or base stations 18 allows the communication terminal 12 to create signal signatures based on signal metrics for the various received signals, associate the signal metrics with a defined location, and subsequently determine that the communication terminal 12 is within the defined location when the communication terminal 12 returns to the defined location and monitors signal metrics indicative of being in the defined location. The signal metrics may related to signal characteristics, signal types, or content transmitted by the received signals.

Once a signal signature has been created for a defined location, and the communication terminal 12 recognizes that it has returned to the defined location based on the signal metrics monitored for the received signals, the communication terminal 12 can take various actions in response to recognizing its current location as being a defined location. Notably, the communication terminal 12 may establish any number of defined locations. Certain of the defined locations may coincide with one another, overlap one another, or be completely isolated from one another. Once the communication terminal 12 has determined that it is at a defined location, numerous actions may be taken. The communication terminal 12 may run its own applications to control functions or operations based on being in a defined location. Alternatively, location-related information may be provided to network entities that will take appropriate action based on the communication terminal's location, or simply store the location information such that other entities may access the location information for the communication terminal 12.

As illustrated, the core communication network 14 may be associated with a service node (SN) 24, a presence server 26, a location server 28, and an application server 30. The service node 24 may act as a call control entity as well as a proxy on behalf of the communication terminal 12, especially for communication sessions involving a local wireless communication session. The service node 24 may use the location-based information to assist in controlling the communication session. For example, the service node 24 may route incoming or outgoing calls based on location information received from the communication terminal 12.

The presence server 26 may implement a presence service, which monitors various information based on the communication terminal's location, the user's location, as well as user or communication terminal activity, to create presence information bearing on the relative availability of the user to engage in communications. Accordingly, the presence information may provide information to other parties relating to when and how best to communicate with the user of the communication terminal 12.

The location server 28 may provide a location service wherein other entities can obtain the location information for the communication terminal 12. The application server 30 may invoke any number of services, such as providing emergency location information upon detecting an emergency event involving the user of the communication terminal 12, or initiating delivery of instructions to activate or deactivate products or functions based on the user's location. For example, location information may be used to control where television content is delivered or to turn on lights and change the thermostat as the user approaches her residence.

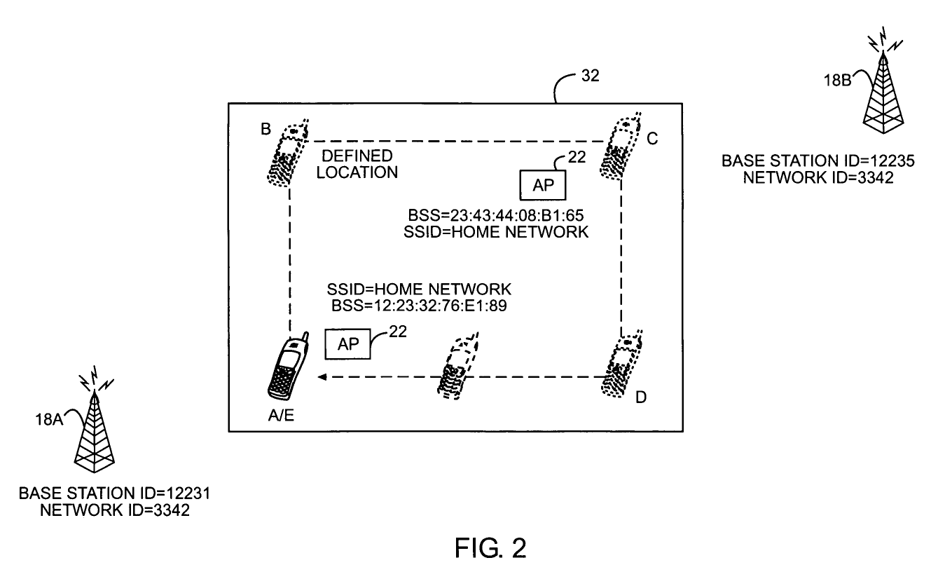

With reference to FIG. 2, a graphical illustration of defining a defined location with the communication terminal 12 is provided. The solid line represents the perimeter of an area 32, such as a warehouse, home, park, or stadium of interest. To define the defined area, the user may move to Position A and instruct the communication terminal 12 to begin a defining process and gather signal metrics for any or select signals that can be received via the cellular and local wireless interfaces. The user may move to Position B, Position C, Position D, and then back to the starting point, which is designated as Position E for clarity, wherein signal metrics are gathered from received signals at each of the respective positions. Assume that at each of the positions A-E, the communication terminal 12 will be able to receive signals from base stations 18A and 18B, as well as access points 22A and 22B. Base station 18A is associated with a base station ID of 12231 and base station 18B is associated with a base station ID of 12235. Both of the base stations 18 are associated with a cellular network ID of 3342. Access point 22A is associated with a basic service set ID (BSS) of 12:23:32:76:E1:89, and access point 22B is associated with a BSS of 23:43:44:08:B1:65. Access points 22A and 22B are both associated with a Service Set Identifier (SSID) named Home Network.

For this illustration, assume that the signal metrics gathered by the communication terminal 12 at each of the four corners of the interior of the area 32 are as follows. For cellular signals, the communication terminal 12 will monitor the power levels of the signals transmitted from base stations 18A and 18B, as well as obtain the network ID associated with the cellular network supporting the base stations 18A and 18B and the respective base station IDs from signals normally transmitted from the base stations 18A and 18B. Similarly, the communication terminal 12 will monitor local wireless signals to gather signal metrics for the SSID and the BSS for the access points 22A and 22B, as well as the power levels associated with signals received from the access points 22A and 22B. Notably, the various identification information may be received in the same or different signals as those in which power levels are gathered.

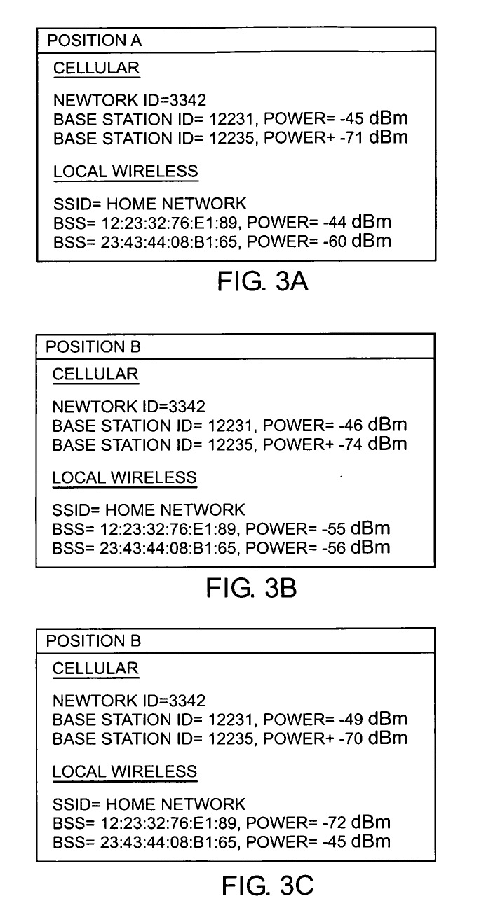

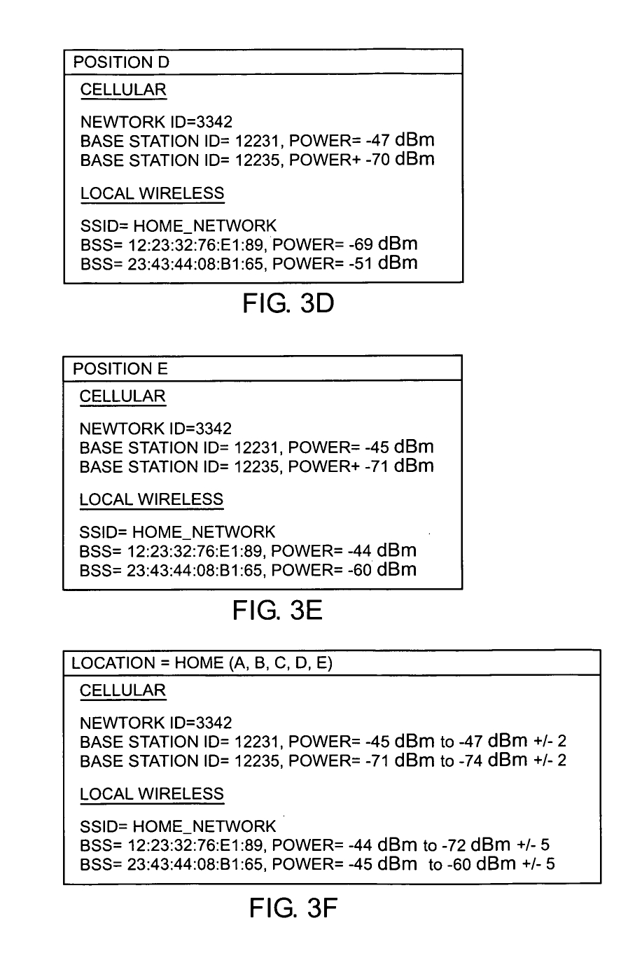

FIGS. 3A-3E provide the signal metrics monitored at each of the five positions where the communication terminal 12 is instructed by the user to gather signal metrics. For this example, positions A and E substantially coincide to represent the start and end points in the defining process. Although the area is defined by the user based on her position or movement throughout a given area 32, the communication terminal 12 may rely on the user to initiate gathering signal metrics for the overall process or throughout the process. Notably, the communication terminal 12 may be configured to automatically take signal metrics on a periodic or systematic basis as the user travels throughout or around an area 32 corresponding to a defined location. Further, the defined location need not be an area over which the user travels, but instead may be an area about a single position. Accordingly, signal metrics for a defined location can be gathered at one or more positions as well as in a substantially continuous fashion along a path taken by the user.

Based on the signal metrics gathered at each of the positions A-E (see FIGS. 3A-3E, respectively), the communication terminal 12 will create a signal signature based on the signal metrics gathered at each of the positions A-E for the defined location. The resultant signal signature may be represented as shown in FIG. 3F, and assigned a name, which may be created by the user via an interaction with the communication terminal 12. In the illustrated example, the defined location is the user's home, and is assigned the name “Home.” When the communication terminal 12 subsequently enters the defined location corresponding to the user's home (within the perimeter of the area 32), the signal metrics being gathered from received signals will fall within the signal signature for the defined location, as provided in FIG. 3F. When the signal metrics fall within the signal signature, the communication terminal 12 will recognize that it is within the defined location for the user's home, and may take appropriate action by sending corresponding location information to a remote entity or provide a local function within the communication terminal 12.

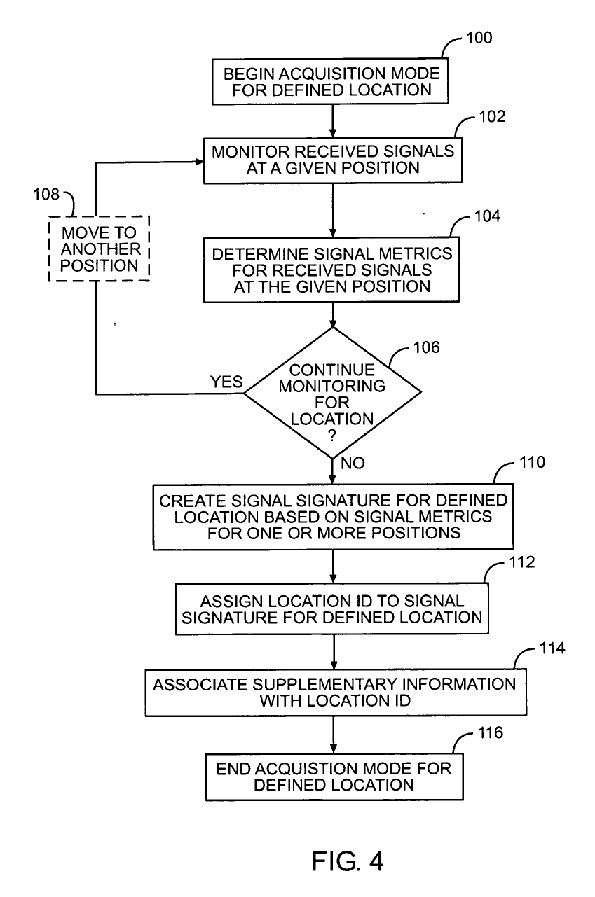

Turning now to FIG. 4, a flow diagram illustrating a process for defining a defined location is provided. In response to user input, the communication terminal 12 will begin an acquisition mode for a defined location (step 100). Accordingly, the communication terminal 12 will receive signals at a given position along or within the area corresponding to the location being defined (step 102) and determine the signal metrics for the received signals at the given position (step 104). The communication terminal 12 will then determine whether to continue monitoring received signals for the defined location (step 106). For example, if signal metrics should be gathered at another position, the communication terminal 12 can move to another position (step 108), wherein the received signals at the new position are monitored (step 102) and signal metrics for the received signals at the new position are determined (step 104).

When sufficient signal metrics are received, or when no more positions for gathering signal metrics are desired or required (step 106), the communication terminal 12 will create a signal signature for the defined location based on the signal metrics for the one or more positions at which signal metrics were monitored (step 110). Notably, not all of the signal metrics monitored need to be used in order to create the signal signature for the defined area. The communication terminal 12 will then assign a location identifier (ID) to the signal signature for the defined location (step 112). In one embodiment, the location ID is one provided by the user, and may be solely user created and defined. If desired, supplementary information may be associated with the location ID based on information available from the communication terminal 12, a remote entity, or the user (step 114). For example, a defined area corresponding to the user's home may have a location ID of Home and supplementary information, such as the physical address of the home. At this point, the acquisition mode for the defined location ends (step 116), and the process may be repeated for any number of locations. Notably, the defined locations are user defined, and may be based on normally transmitted signals of the various communication entities from which signals can be received. Accordingly, the various cellular or local wireless networks need not be reconfigured to support the present invention. The user can use the communication terminal 12 to define numerous defined locations without impacting cellular or local wireless networks.

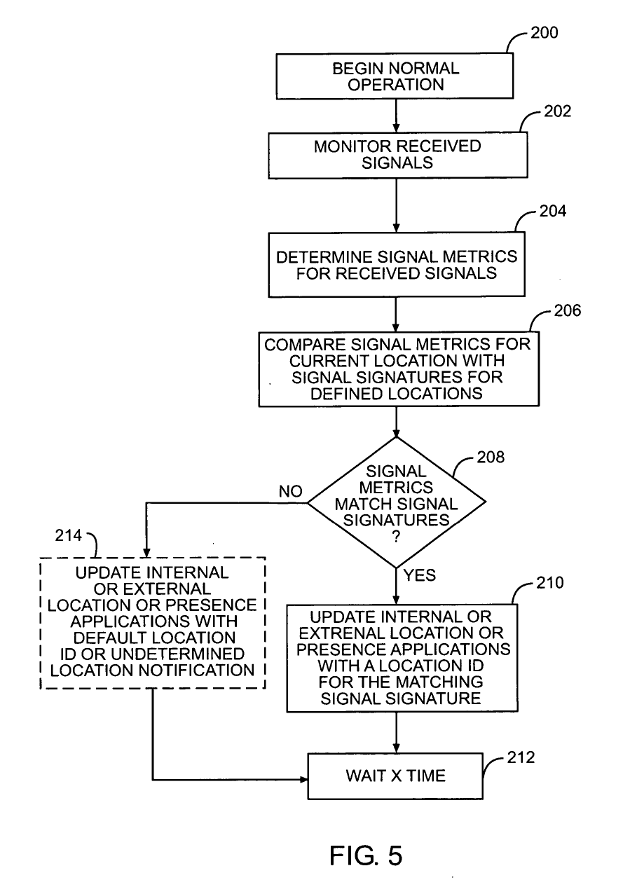

With reference to FIG. 5, a flow diagram is provided for allowing a communication terminal 12 to determine whether it is within a defined location. Initially, the communication terminal 12 will begin normal operation (step 200), such as operating in an idle mode or initiating, receiving, or supporting telephony calls or other multimedia communication sessions. Concurrently, the mobile terminal 12 will monitor received signals, perhaps from both the local wireless and cellular communication interfaces (step 202), and determine the signal metrics for the received signal (step 204). The signal metrics recovered from the received signals are then compared to the signal signatures for any defined locations (step 206). When the signal metrics gathered from the received signals match the signal signatures for a defined location (step 208), the communication terminal 12 will update any internal or external location or presence applications with the location ID corresponding to the signal signature matching the gathered signal metrics (step 210). The communication terminal 12 may take additional or different actions, depending on how the communication terminal 12 is configured to react when it determines that it is within a defined location. The communication terminal 12 may then wait a set amount of time (step 212), wherein the process repeats.

If the signal metrics do not match any available signal signatures (step 208), the communication terminal 12 may update any internal or external location or presence applications with a default location ID, or provide an undetermined location notification (step 214). The communication terminal 12 can then wait a set period of time (step 212), wherein the process repeats. Notably, if the signal metrics do not match a signal signature (step 208), it is possible for no action to be taken, wherein the process will continue to monitor the received signals, determine signal metrics, and compare the signal metrics to the available signal signatures as described. Notably, the operation of the present invention may be selectively activated by a user or the communication terminal 12.

The defined locations may range from an exact position to an entire country. Depending on the size of the area associated with the defined location, the communication terminal 12 need not be moved throughout or around the defined location. For example, a cellular network ID associated with China may be sufficient to define China as a defined location, such that any time the communication terminal 12 is in China, regardless of the specific location within China, the communication terminal 12 can determine that it is located in China and take appropriate action. Thus, a defined location may be established at one position in China, wherein the communication terminal 12 can determine it is in China even when at a different position, as long as the network ID representing the signal signature is the same. Alternatively, a signal signature may be established for an oval-shaped office or octagonal-shaped restaurant. Notably, signal metrics may be received from wired network connections. For example, various signal characteristics and IDs may be obtained from various signals and entities received or monitored while networked to an Ethernet connection.

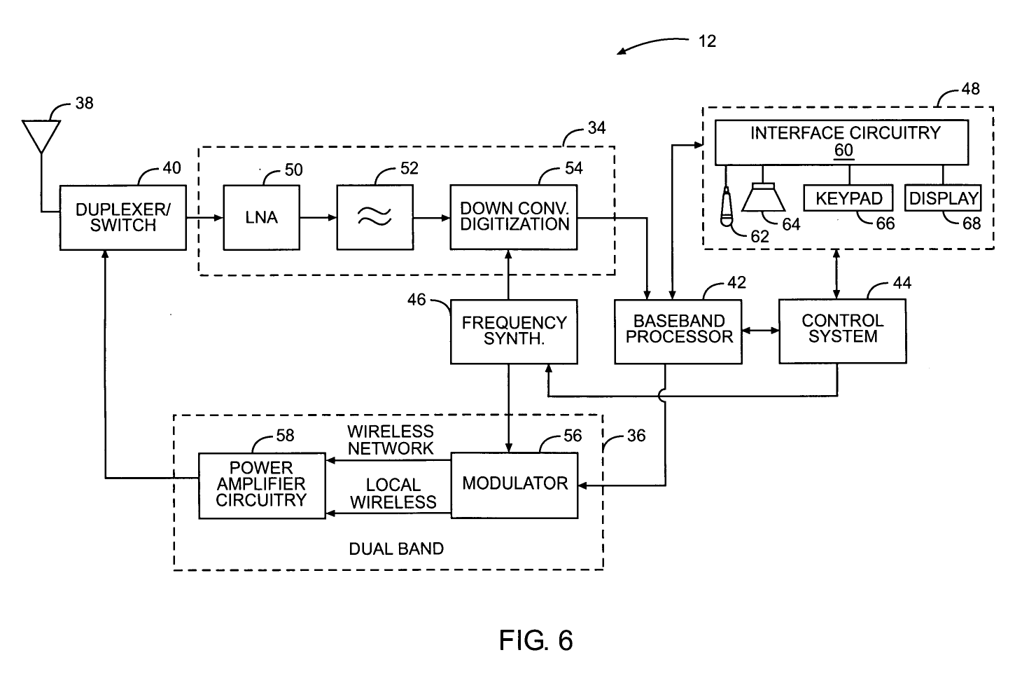

The basic architecture of the communication terminal 12 is represented in FIG. 6 and may include a receiver front end 34, a radio frequency transmitter section 36, an antenna 38, a duplexer or switch 40, a baseband processor 42, a control system 44, a frequency synthesizer 46, and an interface 48. The receiver front end 34 receives information bearing radio frequency signals from one or more remote transmitters provided by a base station 18 or access point 22. A low noise amplifier 50 amplifies the signal. A filter circuit 52 minimizes broadband interference in the received signal, while downconversion and digitization circuitry 54 downconverts the filtered, received signal to an intermediate or baseband frequency signal, which is then digitized into one or more digital streams. The receiver front end 34 typically uses one or more mixing frequencies generated by the frequency synthesizer 46. The baseband processor 42 processes the digitized received signal to extract the information or data bits conveyed in the received signal. This processing typically comprises demodulation, decoding, and error correction operations. As such, the baseband processor 42 is generally implemented in one or more digital signal processors (DSPs).

On the transmit side, the baseband processor 42 receives digitized data, which may represent voice, data, or control information, from the control system 44, which it encodes for transmission. The encoded data is output to the transmitter 36, where it is used by a modulator 56 to modulate a carrier signal that is at a desired transmit frequency. Power amplifier circuitry 58 amplifies the modulated carrier signal to a level appropriate for transmission, and delivers the amplified and modulated carrier signal to the antenna 38 through the duplexer or switch 40.

As noted above, the communication terminal 12 may be able to communicate with the access points 22 to support local wireless communications as well as with the base stations 18 to support cellular communications. Accordingly, the receiver front end 34, baseband processor 42, and radio frequency transmitter section 36 cooperate to provide a cellular interface and a local wireless interface. These functions may be implemented using redundant circuitry, or by configuring common circuitry to operate in different modes. The configuration of the communication terminal 12 will be dictated by economics and designer choice. The communication terminal 12 is configured such that if the local wireless interface is not functional, communications are switched to the cellular interface. Alternatively, the communication terminal 12 could have both the local wireless interface and the cellular interface in operation at the same time and select one of the two for communication at any given.

The cellular and local wireless interfaces will cooperate with the baseband processor 42 and control system 44 to allow the communication terminal 12 to monitor signal metrics for received signals. The control system 44 will process the signal metrics to create signal signatures for defined locations as well as determine when the communication terminal 12 has entered into a defined location by comparing current signal metrics with the previously defined signal signatures.

A user may interact with the communication terminal 12 via the. interface 48, which may include interface circuitry 60 associated with a microphone 62, a speaker 64, a keypad 66, and a display 68. The interface circuitry 60 typically includes analog-to-digital converters, digital-to-analog converters, amplifiers, and the like. Additionally, it may include a voice encoder/decoder, in which case it may communicate directly with the baseband processor 42. The microphone 62 will typically convert audio input, such as the user's voice, into an electrical signal, which is then digitized and passed directly or indirectly to the baseband processor, 42. Audio information encoded in the received signal is recovered by the baseband processor 42, and converted by the interface circuitry 60 into an analog signal suitable for driving the speaker 64. The keypad 66 and display 68 enable the user to interact with the communication terminal 12, input numbers to be dialed, and input address book information, as well as provide instructions to begin, control, and end the defined location process and naming indicia for the defined location.

Those skilled in the art will recognize improvements and modifications to the preferred embodiments of the present invention. All such improvements and modifications are considered within the scope of the concepts disclosed herein and the claims that follow.

What is claimed is:

1. A communication terminal comprising:
at least one wireless communication interface; and
processing circuitry associated with the at least one wireless communication interface and adapted to:
monitor received signals received via the at least one wireless communication interface at least one given position associated with a defined location;
determine signal metrics for the received signals at the at least one given position;
create a signal signature based on the signal metrics for the defined location; and
assign a location identifier for the signal signature.

2. The communication terminal of claim 1 wherein the processing circuitry is further adapted to:
monitor received signals received via the at least one wireless communication interface at a current position of the communication terminal;
determine signal metrics for the received signals at the current position;
compare the signal metrics for the received signals at the current position with the signal signature for the defined location; and
determine the communication terminal is within the defined location when the signal metrics for the received signals at the current position correspond with the signal signature for the defined location.

3. The communication terminal of claim 2 wherein the processing circuitry is further adapted to initiate an operation when the communication terminal is determined to be at the defined location.

4. The communication terminal of claim 3 wherein the operation is sending to a remote entity via the at least one wireless communication interface location information bearing on the communication terminal being at the defined location.

5. The communication terminal of claim 1 further comprising a user interface associated with the processing circuitry, the processing circuitry further adapted to receive user input via the user interface and control creation of the signal signature for the defined location based on the user input.

6. The communication terminal of claim 5 wherein the location identifier is received from the user via the user interface.

7. The communication terminal of claim 1 wherein the processing circuitry is further adapted to assign supplementary data with the signal signature.

8. The communication terminal of claim 1 wherein the at least one given position is a single position associated with the defined location, and the signal metrics are determined for the received signals at the single position.

9. The communication terminal of claim 8 wherein the single position corresponds to an area.

10. The communication terminal of claim 1 wherein the at least one given position is a plurality of positions associated with the defined location, and the signal metrics are determined for the received signals at each of the plurality of positions.

11. The communication terminal of claim 10 wherein the defined location is an area and the plurality of positions are along a perimeter of the area.

12. The communication terminal of claim 10 wherein the defined location is an area and the plurality of positions are within the area.

13. The communication terminal of claim 1 wherein the at least one wireless communication interface is adapted to receive cellular and local wireless signals, the received signals at the at least one given position comprise cellular and local wireless signals, and the signal metrics are determined from the cellular and local wireless signals.

14. The communication terminal of claim 1 wherein the signal metrics correspond to characteristics of the received signals.

15. The communication terminal of claim 14 wherein the signal metrics correspond to signal or power levels of the received signals.

16. The communication terminal of claim 1 wherein the signal metrics correspond to a type of the received signals.

17. The communication terminal of claim 1 wherein the signal metrics correspond to content of the received signals.

18. The communication terminal of claim 17 wherein the signal metrics correspond to an identification of at least one of the group consisting of a cell, zone, access point, base station, and network associated with the received signals.

19. The communication terminal of claim 17 wherein the signal metrics correspond to an address associated with the received signals.

20. The communication terminal of claim 1 wherein the signal metrics correspond to signal characteristics and content of the received signals.

21. A method for operating a communication terminal comprising:
monitoring received signals received at least one given position associated with a defined location;
determining signal metrics for the received signals at the at least one given position;
creating a signal signature based on the signal metrics for the defined location; and
assigning a location identifier for the signal signature.

22. The method of claim 21 comprising:
monitoring received signals received at a current position of the communication terminal;
determining signal metrics for the received signals at the current position;
comparing the signal metrics for the received signals at the current position with the signal signature for the defined location; and
determining the communication terminal is within the defined location when the signal metrics for the received signals at the current position correspond with the signal signature for the defined location.

23. The method of claim 21 wherein the defined location is defined by a user.
